(19) United States
(12) Patent Application Publication
(10) Pub. No.: US 2018/0202444 A1
(43) Pub. Date: Jul. 19, 2018

(54) PRESS FIT TIMING GEAR HAVING WEB CONFIGURATION AND INSERT MOLDED COUPLING FOR SUPERCHARGER

(71) Applicant: Eaton Corporation, Cleveland, OH (US)

(72) Inventors: Benjamin S. Sheen, Schoolcraft, MI (US); Justin Hopkins, Battle Creek, MI (US); Sandeep Kumar, Pune (IN); Daniel Ouwenga, Portage, MI (US)

(73) Assignee: Eaton Corporation, Cleveland, OH (US)

(21) Appl. No.: 15/924,260

(22) Filed: Mar. 18, 2018

Related U.S. Application Data
(63) Continuation of application No. PCT/US2016/052029, filed on Sep. 16, 2016.
(60) Provisional application No. 62/394,850, filed on Sep. 15, 2016.

(30) Foreign Application Priority Data
Sep. 18, 2015 (IN) 2963/DEL/2015

(51) Int. Cl. F04C 29/00; F02B 33/38; F02B 39/04; F04C 18/12

(52) U.S. Cl. CPC F04C 29/005; F02B 33/38; F04C 2240/805; F04C 18/126; F02B 39/04

(57) ABSTRACT

A supercharger constructed in accordance to one example of the present disclosure includes a housing, a first rotor, a second rotor, a first timing gear, a second timing gear, a first rotor shaft, a second rotor shaft and a coupling. The first and second rotors are received in cylindrical overlapping chambers of the housing. The first timing gear has a gear body that includes first helical teeth. The gear body further defines a central bore and a series of openings. The second timing gear has second helical teeth and is arranged in meshed engagement with the first timing gear. The first rotor shaft supports the first rotor and the first timing gear. The second rotor shaft supports the second rotor and the second timing gear. The coupling has a coupling body and includes a series of protrusions configured to be inserted into the series of openings of the gear body.

### CROSS-REFERENCE TO RELATED APPLICATIONS

This application is a continuation of International Application No. PCT/US2016/052029 filed on Sep. 16, 2016, which claims the benefit of Indian Patent Application No. 2963/DEL/2015 filed on Sep. 18, 2015 and U.S. Patent Application No. 62/394,850 filed on Sep. 15, 2016. The disclosures of the above applications are incorporated herein by reference.

### FIELD

The present disclosure relates generally to superchargers and more particularly to a supercharger that incorporates a timing gear having a web configuration and an insert molded coupling.

### BACKGROUND

Rotary blowers of the type to which the present disclosure relates are referred to as “superchargers” because they effectively super charge the intake of the engine. One supercharger configuration is generally referred to as a Roots-type blower that transfers volumes of air from an inlet port to an outlet port. A Roots-type blower includes a pair of rotors which must be timed in relationship to each other, and therefore, can be driven by meshed timing gears. Typically, a pulley and belt arrangement for a Roots blower supercharger is sized such that, at any given engine speed, the amount of air being transferred into the intake manifold is greater than the instantaneous displacement of the engine, thus increasing the air pressure within the intake manifold and increasing the power density of the engine.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A supercharger constructed in accordance to one example of the present disclosure includes a housing, a first rotor, a second rotor, a first timing gear, a second timing gear, a first rotor shaft, a second rotor shaft and a coupling. The first and second rotors are received in cylindrical overlapping chambers of the housing. The first timing gear has a gear body that includes first helical teeth around an outer diameter thereof. The gear body further defines a central bore and a series of openings. The second timing gear has second helical teeth and is arranged in meshed engagement with the first timing gear such that the second timing gear is driven by the first timing gear. The first rotor shaft supports the first rotor and the first timing gear. The second rotor shaft supports the second rotor and the second timing gear. The coupling has a coupling body and includes a series of protrusions configured to be inserted into the series of openings of the gear body.

According to additional features, the first timing gear includes a web configuration having a series of spokes alternately arranged between adjacent openings of the series of openings. The openings in the gear body are arcuately shaped. Each protrusion of the series of protrusions is kidney shaped. Each protrusion of the series of protrusions includes end lobes connected by an intermediate portion. The end lobes provide a clearance fit with the gear body at the respective openings. The coupling body further defines an inner diameter configured to receive a central protrusion of an input hub.

According to other features, the coupling body defines fastener passages therethrough configured to receive fasteners that mate with the input hub. The coupling body defines blind bores alternately arranged with the fastener passages. The blind bores are configured to receive pins that mate with the input hub. The coupler can be insert molded and formed with glass-filled nylon. The first and second timing gears rotate at the same rate as the first and second rotors. Axial movement of the first rotor shaft causes the first helical teeth on the first timing ear to rotate the second helical teeth on the second timing gear. Axial movement of the second rotor shaft causes the second helical teeth on the second timing gear to rotate the first helical teeth on the first timing gear. Both of the first and second timing gears and the first and second rotors twist at an equivalent rate of angular displacement such that a space between the first and second rotors remains constant.

A supercharger constructed in accordance to another example of the present disclosure includes a housing, a first rotor, a second rotor, a first timing gear, a second timing gear, a first rotor shaft, a second rotor shaft and a coupling. The first and second rotors are received in cylindrical overlapping chambers of the housing. The first timing gear has a gear body that includes first helical teeth around an outer diameter thereof.

The gear body further has a web configuration including a series of spokes alternately arranged between a series of openings. The second timing gear has second helical teeth. The second timing gear is arranged in meshed engagement with the first timing gear such that the second timing gear is driven by the first timing gear. The first rotor shaft supports the second rotor and the second timing gear. The coupling has a coupling body having a series of protrusions, wherein each protrusion of the series of protrusions includes end lobes. The protrusions are received into the series of openings in the gear body, respectively.

According to additional features, each protrusion of the series of protrusions is each kidney shaped. The end lobes of a protrusion of the series of protrusions are connected by a respective intermediate portion. The end lobes provide a clearance fit with the gear body at the respective openings. The coupling body further defines an inner diameter configured to receive a central protrusion of an input hub. The coupling body defines fastener passages therethrough configured to receive fasteners that mate with the input hub. The coupler is insert molded and formed with glass-filled nylon.

### BRIEF DESCRIPTION OF THE DRAWINGS

The present disclosure will become more fully understood from the detailed description and the accompanying drawings, wherein:

FIG. 1 is a schematic illustration of an intake manifold assembly having a positive displacement blower or supercharger constructed in accordance to one example of the present disclosure;

FIG. 2 is a front perspective view of a pair of rotor shafts and corresponding timing gears constructed in accordance to one example of the present disclosure;

FIG. 3 is a front perspective view of a timing gear constructed in accordance to prior art;

FIG. 4 is a front perspective view of a timing gear constructed in accordance to the present disclosure;

FIG. 5 is a rear perspective view of the timing gear shown in FIG. 4;

FIG. 6 is a top view of an exemplary supercharger incorporating the timing gears of FIG. 4 and an insert molded coupling according to additional features of the present disclosure;

FIG. 7 is a perspective view of an insert molded coupling constructed in accordance to one example of the present disclosure;

FIG. 8 is a sectional view of the insert molded coupling of FIG. 7 and shown assembled with a timing gear; and

FIG. 9 is an exploded view of an input hub, the insert molded coupling and timing gear of the present disclosure.

### DETAILED DESCRIPTION

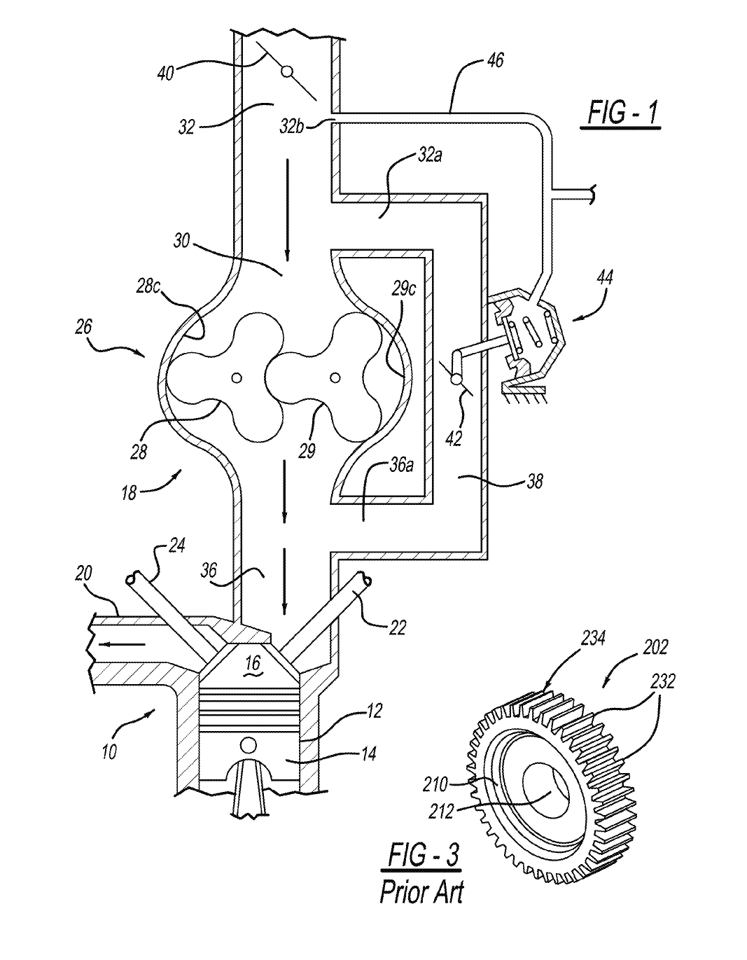

With initial reference to FIG. 1, a schematic illustration of an exemplary intake manifold assembly, including a Roots blower supercharger and bypass valve arrangement is shown. An engine 10 can include a plurality of cylinders 12, and a reciprocating piston 14 disposed within each cylinder and defining an expandable combustion chamber 16. The engine 10 can include intake and exhaust manifold assemblies 18 and 20, respectively, for directing combustion air to and from the combustion chamber 16, by way of intake and exhaust valves 22 and 24, respectively.

The intake manifold assembly 18 can include a positive displacement rotary blower 26, or supercharger of the Roots type. Further description of the rotary blower 26 may be found in commonly owned U.S. Pat. Nos. 5,078,583 and 5,893,355, which are expressly incorporated herein by reference. The blower 26 includes a pair of rotors 28 and 29, each of which includes a plurality of meshed lobes. The rotors 28 and 29 are disposed in a pair of parallel, transversely overlapping cylindrical chambers 28c and 29c, respectively. The rotors 28 and 29 may be driven mechanically by engine crankshaft torque transmitted thereto in a known manner, such as by a drive belt (not specifically shown). The mechanical drive rotates the blower rotors 28 and 29 at a fixed ratio, relative to crankshaft speed, such that the displacement of the blower 26 is greater than the engine displacement, thereby boosting or supercharging the air flowing to the combustion chambers 16.

The supercharger 26 can include an inlet port 30 which receives air or air-fuel mixture from an inlet duct or passage 32, and further includes a discharge or outlet port 34, directing the charged air to the intake valves 22 by means of a duct 36. The inlet duct 32 and the discharge duct 36 are interconnected by means of a bypass passage, shown schematically at reference 38. If the engine 10 is of the Otto cycle type, a throttle valve 40 can control air or air-fuel mixture flowing into the intake duct 32 from a source, such as ambient or atmospheric air, in a well know manner. Alternatively, the throttle valve 40 may be disposed downstream of the supercharger 26.

A bypass valve 42 is disposed within the bypass passage 38. The bypass valve 42 can be moved between an open position and a closed position by means of an actuator assembly 44. The actuator assembly 44 can be responsive to fluid pressure in the inlet duct 32 by a vacuum line 46. The actuator assembly 44 is operative to control the supercharging pressure in the discharge duct 36 as a function of engine power demand. When the bypass valve 42 is in the fully open position, air pressure in the duct 36 is relatively low, but when the bypass valve 42 is fully closed, the air pressure in the duct 36 is relatively high. Typically, the actuator assembly 44 controls the position of the bypass valve 42 by means of a suitable linkage. The bypass valve 42 shown and described herein is merely exemplary and other configurations are contemplated. In this regard, a modular (integral) bypass, an electronically operated bypass, or no bypass may be used.

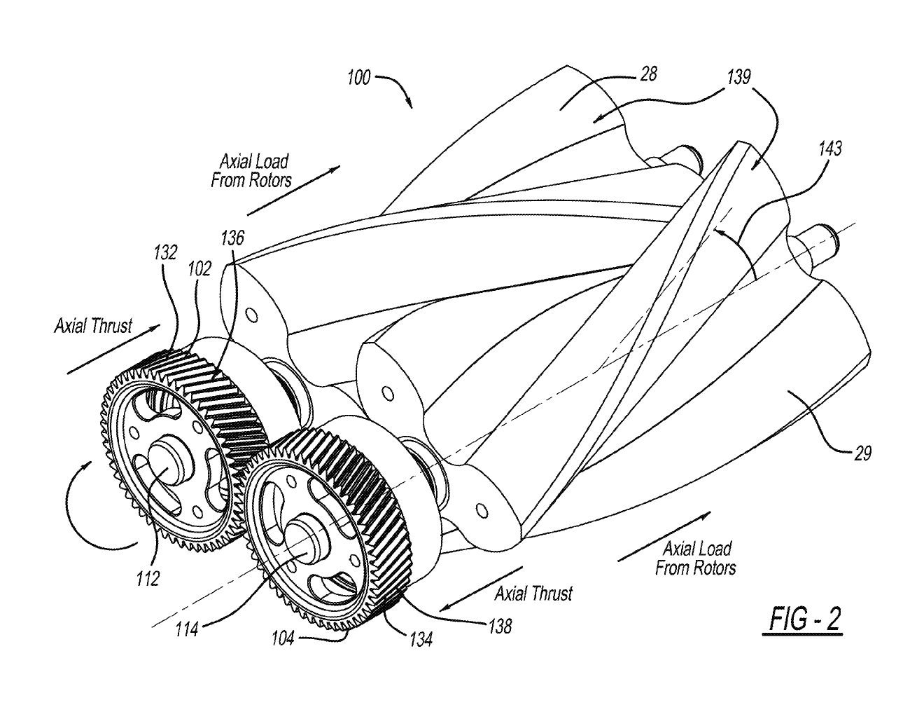

With particular reference now to FIG. 2, additional features of the supercharger 26 will be described in greater detail. The supercharger 26 according to the present disclosure includes a rotor assembly 100 that includes a first and second timing gear 102 and 104 that are mounted on the end of respective rotor shafts 112 and 114. In the example shown, the first timing gear 102 is a drive gear while the second timing gear 104 is a driven gear. The first and second timing gears 102 and 104 incorporate helical teeth 132 and 134, respectively. The helical teeth 132 and 134 are in meshed engagement. The second rotor shaft 114 is therefore driven as a result of the meshed engagement of the helical teeth 132 and 134 of the respective timing gears 102 and 104.

According to the present disclosure, the timing gears 102 and 104 twist (rotate) at the same rate as the rotors 28 and 29. Explained further, the first and second timing gears 102 and 104 have a helix angle (or lead) 136 and 138, respectively. The first and second rotors 28 and 29 have a helix angle (or lead 143 identified on second rotor 29), respectively. The axial lead 136 and 138 of the timing gears 102 and 104 match the axial lead (identified at reference 143) of the rotors 28 and 29. Any thrust loads and axial movement of the rotor shafts 112 and 114 will not change the timing of the rotor assembly 100. In this regard, the rotor shafts 112 and 114 are precluded from rotating. As a result, the side clearances between the rotors 28 and 29 are maintained. Therefore, a coating 139 on the rotors 28 and 29 will be maintained improving efficiency.

Further, the configuration of the rotor assembly 100 maintains the timing of the rotating rotor group independent of axial movement of the rotor shafts 112 and 114. Both the first and second timing gears and the rotors 28 and 29 twist at the same exact rate of angular displacement such that a space between the first and second rotors 28 and 29 remains constant. When the timing gears 102 and 104 are synchronized with the rotors 28 and 29, as the rotor shafts 112 and 114 move axially (such as due to bearing internal clearances), the timing gears 102 and 104 rotate the rotor shafts 112 and 114 at the same twist as the rotors 28 and 29. In addition, any thermal growth such as axially along the rotor shafts 112 and 114 will also occur at the same rate. In this regard, the clearances (gap or channel) between the rotors 28 and 29 can be maintained without abrading and/or compromising the rotor coating and ultimately compromising efficiency. In another advantage the helical timing gears 102 and 104 reduces operating noise of the supercharger 26 over prior art configurations that incorporate conventional spur gears.

In one configuration, positive torque is transmitted from an internal combustion engine (of the periodic combustion type) to the input shaft (see 416, FIG. 8) by any suitable drive means, such as a belt and pulley drive system. Torque is transmitted from the input shaft to the rotor assembly 100 through a coupling or isolator assembly. The isolator assembly can provide torsional and axial damping and can further account for misalignment between the input shaft and the rotor shaft 112. When the engine is driving the timing gears 102 and 104, and the blower rotors 28 and 29, such is considered to be transmission of positive torque. On the other hand, whenever the momentum of the rotors 28 and 29 overruns the input from the input shaft, such is considered to be the transmission of negative torque.

Turning now to FIG. 3, a timing gear constructed in accordance to prior art is shown and generally identified at reference 202. The timing gear 202 includes a gear body 210 that defines a central bore 212. The timing gear 202 incorporates conventional teeth 232 around an outer diameter 234. The body 210 is solid from the central bore 212 to the outer diameter 234 at the teeth 232.

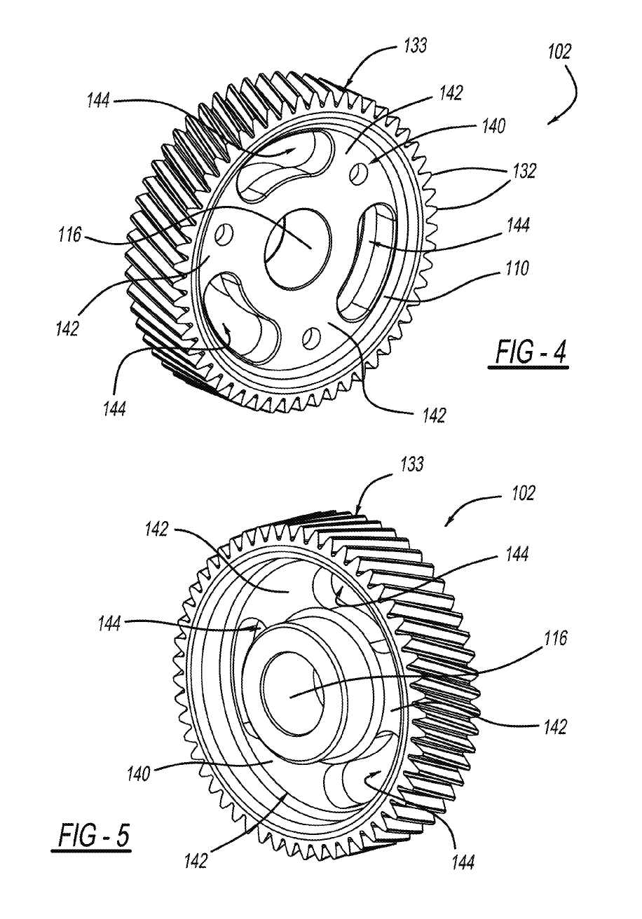

With reference now to FIGS. 4 and 5, additional features of the timing gear 102 will be described. While one timing gear 102 is described below it is appreciated that two timing gears constructed similarly (with helical gears formed in complementary manner) can be provided as a drive gear and a driven gear pair. The timing gear 102 includes a gear body 110 that defines a central bore 116. The timing gear 102 can be mounted on the end of a respective rotor shaft such as by press-fit (see FIG. 2). The timing gear 102 incorporates the helical teeth 132 around an outer diameter 133 as described above. The gear body 110 further includes a web configuration 140 having a series of spokes 142 and a series of openings 144. While three spokes 142 and openings 144 are shown, other quantities may be incorporated. The openings 144 are arcuate in shape and generally follow the profile of the outer diameter 133 of the timing gear 102.

The timing gear 102 provides many advantages over prior art timing gears such as the timing gear 202. The openings 144 are designed to accommodate coupler protrusions, as will be described more fully herein, and transfer driving torque and speed to the rotor shaft 112 and the adjacent timing gear 104. Clearance on the openings 144 are designed to accommodate manufacturing variations between subassemblies and to allow easy assembly.

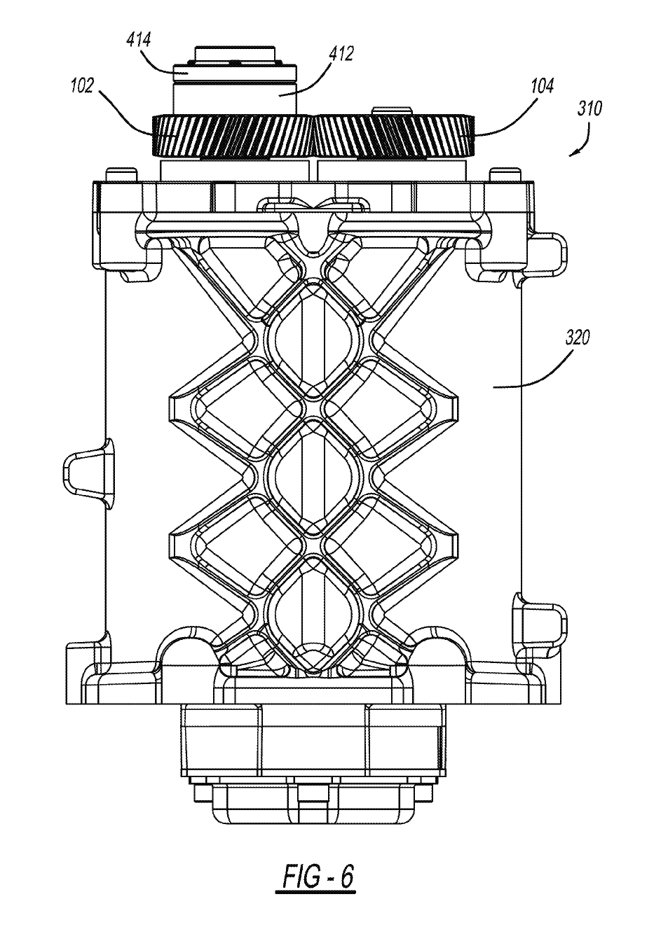

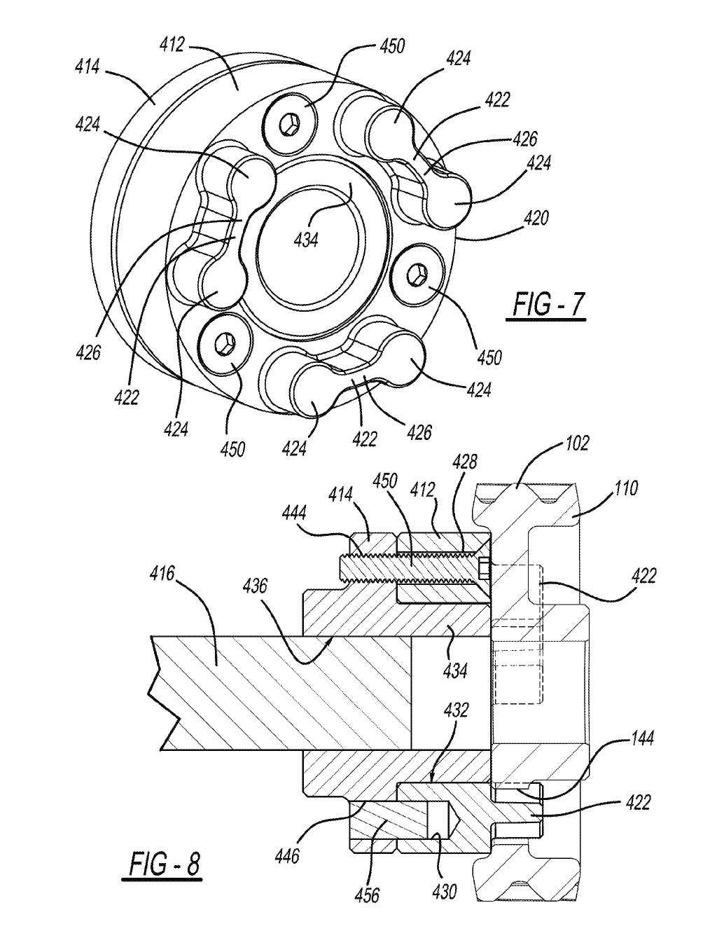

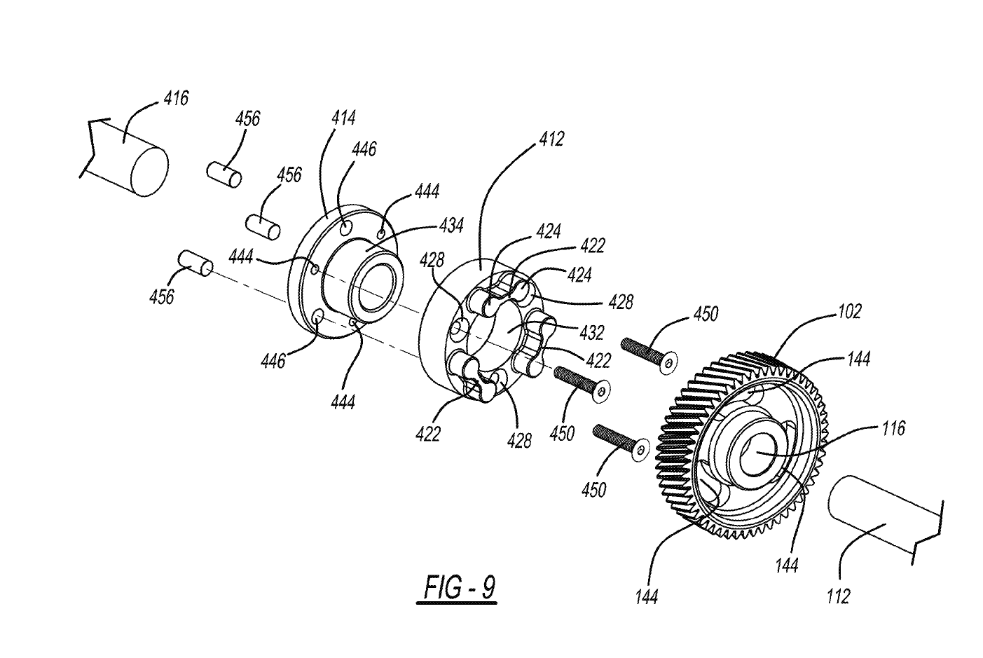

Turning now to FIGS. 6-8, a supercharger 310 is shown incorporating timing gears 102 and 104 discussed above. The supercharger 310 includes a housing 320 that defines the overlapping cylindrical chambers 28c and 29c. An insert molded coupling 412 constructed in accordance to one example of the present disclosure is shown. The insert molded coupling 412 connects to the timing gear 102 and to an input hub 414. Once assembled, the insert molded coupling 412 connects between the timing gear 102 and input hub 414 such that an input shaft 416 (FIG. 8) can transmit rotational motion to the rotor shaft 112. The insert molded coupling 412 mates directly into the web configuration 140 of the timing gear 102. The insert molded coupling 412 includes a coupling body 420 having a series of dog bone or kidney shaped protrusions 422. The protrusions 422 include end lobes 424 connected by an intermediate portion 426.

The kidney shaped protrusions 422 are configured to be inserted into the openings 144. In an assembled position, the kidney shaped protrusions 422 extend into the openings 144 in a clearance fit causing the insert molded coupling 412 to be rotationally coupled to the gear body 110 of the timing gear 102. In some examples the clearance fit between the protrusions 422 and the gear body 110 at the openings can have a minimal clearance such as 0.1 mm to allow for assembly. Other configurations are contemplated. As can be appreciated, in the assembled position, once initial rotation has occurred to take up the clearance, the coupling 412 is fixed for rotation with the timing gear 102. Fastener passages 428 (FIG. 8) and blind bores 430 are alternately arranged around the insert molded coupling 412. The insert molded coupling 412 can be formed of glass-filled nylon such as Nylon 46 with 30% glass fiber. In other examples, the insert molded coupling 412 can be formed of Polyether ether ketone (PEEK).

The coupling body 420 further defines an inner diameter 432 configured to receive a central protrusion 434 of the input hub 414. The input shaft 416 can be press-fit into an inner diameter 436 of the input hub 414. The input hub 414 can define alternately arranged fastener passages 444 and pin bores 446 thereon. In one example, the fastener passages 444 can be threaded. When assembled, fasteners 450 extend through the fastener passages 428 of the insert molded coupling 412 and threadably mate with the fastener passages 444 of the input hub 414. Similarly, dowels or pins 465 extend through the pin bores 446 of the input hub 414 and into the blind bores 430 of the insert molded coupling 412.

The foregoing description of the examples has been provided for purposes of illustration and description. It is not intended to be exhaustive or to limit the disclosure. Individual elements or features of a particular example are generally not limited to that particular example, but, where applicable, are interchangeable and can be used in a selected example, even if not specifically shown or described. The same may also be varied in many ways. Such variations are not to be regarded as a departure from the disclosure, and all such modifications are intended to be included within the scope of the disclosure.

What is claimed is:

1. A supercharger comprising:
a housing;
a first rotor and a second rotor received in cylindrical overlapping chambers of the housing;
a first timing gear having a gear body that includes first helical teeth around an outer diameter thereof, the gear body further defining a central bore and series of openings;
a second timing gear having second helical teeth, the second timing gear arranged in meshed engagement with the first timing gear such that the second timing gear is driven by the first timing gear;
a first rotor shaft that supports the first rotor and the first timing gear;
a second rotor shaft that supports the second rotor and the second timing gear; and
a coupling having a coupling body that includes a series of protrusions configured to be inserted into the series of openings in the gear body, respectively.

2. The supercharger of claim 1 wherein the first timing gear includes a web configuration having a series of spokes alternately arranged between adjacent openings of the series of openings.

3. The supercharger of claim 2 wherein the openings in the gear body are arcuately shaped.

4. The supercharger of claim 1 wherein each protrusion of the series of protrusions is kidney shaped.

5. The supercharger of claim 4 wherein each protrusion of the series of protrusions includes end lobes connected by an intermediate portion.

6. The supercharger of claim 4 wherein the end lobes provide a clearance fit with the gear body at the respective openings.

7. The supercharger of claim 1 wherein the coupling body further defines an inner diameter configured to receive a central protrusion of an input hub.

8. The supercharger of claim 7 wherein the coupling body defines fastener passages therethrough configured to receive fasteners that mate with the input hub.

9. The supercharger of claim 8 wherein the coupling body defines blind bores alternately arranged with the fastener passages, the blind bores configured to receive pins that mate with the input hub.

10. The supercharger of claim 1 wherein the coupler is insert molded and formed with glass-filled nylon.

11. The supercharger of claim 1 wherein the first and second timing gears rotate at the same rate as the first and second rotors.

12. The supercharger of claim 11 wherein (i) axial movement of the first rotor shaft causes the first helical teeth on the first timing gear to rotate the second helical teeth on the second timing gear and wherein (ii) axial movement of the second rotor shaft causes the second helical teeth on the second timing gear to rotate the first helical teeth on the first timing gear.

13. The supercharger of claim 12 wherein both the first and second timing gears and the first and second rotors twist at an equivalent rate of angular displacement such that a space between the first and second rotors remains constant.

14. A supercharger comprising:
a housing;
a first rotor and a second rotor received in cylindrical overlapping chambers of the housing;
a first timing gear having a gear body that includes first helical teeth around an outer diameter thereof, the gear body further having a web configuration including a series of spokes alternately arranged between a series of openings;
a second timing gear having second helical teeth, the second timing gear arranged in meshed engagement with the first timing gear such that the second timing gear is driven by the first timing gear;
a first rotor shaft that supports the first rotor and the first timing gear;
a second rotor shaft that supports the second rotor and the second timing gear; and
a coupling having a coupling body having a series of protrusions, wherein each protrusion of the series of protrusions includes end lobes, wherein the protrusions are received into the series of openings in the gear body, respectively.

15. The supercharger of claim 14 wherein each protrusion of the series of protrusions is kidney shaped.

16. The supercharger of claim 15 wherein the end lobes of a protrusion of the series of protrusions are connected by a respective intermediate portion.

17. The supercharger of claim 16 wherein the end lobes provide a clearance fit with the gear body at the respective openings.

18. The supercharger of claim 14 wherein the coupling body further defines an inner diameter configured to receive a central protrusion of an input hub.

19. The supercharger of claim 14 wherein the coupling body defines fastener passages therethrough configured to receive fasteners that mate with the input hub.

20. The supercharger of claim 14 wherein the coupler is insert molded and formed with glass-filled nylon.
